(19) United States
(12) Patent Application Publication
(10) Pub. No.: US 2006/0184800 A1
(43) Pub. Date: Aug. 17, 2006

(54) Method and apparatus for using age and/or gender recognition techniques to customize a user interface

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: Outland Research, LLC, Pismo Beach, CA (US)

(21) Appl. No.: 11/282,379

(22) Filed: Nov. 18, 2005

Related U.S. Application Data
(60) Provisional application No. 60/653,975, filed on Feb. 16, 2005.

(51) Int. Cl. H04K 1/00

(52) U.S. Cl. 713/186

(57) ABSTRACT

A method of customizing a user interface with respect to a user, includes capturing biometric data of a user engaging a user interface; identifying a characteristic feature within the captured biometric data; identifying a demographic group to which the user belongs based on the characteristic feature identified; and modifying a presentation characteristic of the user interface based on the identified demographic group of the user.

This application claims the benefit of U.S. Provisional Application No. 60/653,975, filed Feb. 16, 2005, which is incorporated in its entirety herein by reference.

### BACKGROUND OF THE INVENTION

1. Field of the Invention

The present invention relates generally to methods and apparatus that facilitate the customization of user interfaces based (e.g., in whole or in part) on an automatically identified demographic group to which a user belongs.

2. Discussion of the Related Art

A number of systems and methods are known to the art for identifying the gender of a person from video images using computer vision and image processing techniques. For example, the paper “Identity and Gender Recognition Using the ENCARA Real-Time Face Detector” by M. Castrillon, O. Deniz, D. Hernandez, and A. Dominguez discloses methods of using real-time image detection and processing techniques to identify the gender of a user based upon a video image of their face. This paper is hereby incorporated by reference for all purposes as if fully set forth herein. Other methods have been developed for both estimating age and identifying gender of a user based upon processed video images of the user's face. For example, the paper “A Method for Estimating and Modeling Age and Gender using Facial Image Processing” by J. Hayashi, M. Yasumoto, H. Ito, and H. Koshimizu was published in 2001 in the Seventh International Conference on Virtual Systems and Multimedia (VSMM'01). This paper, which is hereby incorporated by reference for all purposes as if fully set forth herein, discloses methods known to the art for both identifying general age groupings as well as identifying gender of users based upon computer processed images of a users face. For example, face size, face shape, and the presence and/or absence of wrinkles are used for automated age estimation and/or gender recognition. Determining gender from a user's vocalizations by capturing and processing speech on a computer is also an area work known to the art. For example, the 1991 papers “Gender recognition from speech. Part I: Coarse analysis” and “Gender recognition from speech. Part II: fine analysis,” both by Wu K, and Childers D G., disclose computer automated methods of identifying the gender of a person based upon the digital processing of recorded signals representing their speech. Both of these papers are hereby incorporated by reference for all purposes as if fully set forth herein. Finally methods exist in the art for automatically estimating a speakers age based upon the computer processing of their captured voice. In a paper published on the Web in 2003 entitled “Automatic prediction of speaker age using CART” by Susanne, a method is disclosed of using CART or Classification and Regression Trees to process a human voice on a computer and estimate the speakers age. This paper, hereby incorporated by reference for all purposes as if fully set forth herein, along with the other papers cited above and also incorporated by reference for all purposes as if fully set forth herein.

Interactive media, such as the Internet, allows for the targeting of advertisements to users based upon their web-related activities as disclosed in pending US Patent Application Publication No. 2004/0059708, entitled Methods and apparatus for serving relevant advertisements which was filed Dec. 6, 2002 and is hereby incorporated by reference for all purposes as if fully set forth herein. For example, some websites provide an information search functionality that is based on query keywords entered by the user seeking information. This user query can be used as an indicator of the type of information of interest to the user. By comparing the user query to a list of keywords specified by an advertiser, it is possible to provide some form of targeted advertisements to these search service users. An example of such a system is the Adwords system offered by Google, Inc. While systems such as Adwords have provided advertisers the ability to better target ads, their effectiveness is limited to sites where a user enters a search query to indicate their topic of interest. Most web pages, however, do not offer search functionality and for these pages it is difficult for advertisers to target their ads. As a result, often, the ads on non-search pages are of little value to the viewer of the page and are therefore viewed more as an annoyance than a source of useful information. Not surprisingly, these ads typically provide the advertiser with a lower return on investment than search-based ads, which are more targeted.

Other methods and apparatus have been developed for providing relevant ads for situations where a document is provided to an end user, but not in response to an express indication of a topic of interest by the end user. These methods work by analyzing the content of a target document to identify a list of one or more topics for the target document, comparing the targeting information to the list of advertising topics to determine if a match exists, and determining that a particular advertisement is relevant to the target document if the match exists. While such methods offer improved automatic targeting of advertisements to users, they do not account for the fact that users of different ages are often targeted with different advertisements by advertisers. Such methods also do not account for the fact that users of different genders are often targeted with different advertisements by advertisers.

Even in cases when the advertised product is the same, the optimal form, format, and/or content of an advertisement promoting that product is often different for users of different ages and/or genders. For example, an effective advertisement for a particular make and model of automobile is presented in a very different format (e.g., different look, different music, different informational content, etc.) depending upon whether the intended recipient of that advertisement is male or female and/or depending upon the age of the intended recipient. Current internet-based advertisement targeting techniques, however, do not account for the gender and/or age of the intended recipient. In light of the above, there is a need for a method and/or apparatus that can be used to improve the targeting of advertisements served over the internet to users by identifying age and/or genders of users.

Moreover, it is appreciated that people of different ages and/or different genders respond differently, on average, to people of particular ages and genders in social settings. Accordingly, different users experience the same user interface (i.e., the means by which a system presents itself to, and interacts with, a human user) differently. As a result, the experience a particular user has with a one-size-fits-all user interface may lead to user frustration and an inability to quickly and easily access/input desired information, in addition to ineffective targeting of advertisements to users, and other problems. Accordingly, there is a general need for methods and/or apparatus that can be used to improve the customization of user interfaces by identifying age groups and/or genders of users.

### SUMMARY OF THE INVENTION

Several embodiments of the invention advantageously address the needs above as well as other needs by providing methods and apparatus that facilitate the customization of user interfaces based (e.g., in whole or in part) on an automatically identified demographic group to which a user belongs.

In one embodiment, the invention can be characterized as a method of customizing a user interface with respect to a user that includes capturing biometric data of a user engaging a user interface; identifying a characteristic feature within the captured biometric data; identifying a demographic group to which the user belongs based on the characteristic feature identified; and modifying a presentation characteristic of the user interface based on the identified demographic group of the user.

In another embodiment, the invention can be characterized as an apparatus for customizing a user interface with respect to a user that includes biometric recognition circuitry and user interface modification circuitry. The biometric recognition circuitry is adapted to identify a characteristic feature within captured biometric data of a user engaging a user interface; and identify a demographic group to which the user belongs based on the characteristic feature identified. The user interface modification circuitry is adapted to modify a presentation characteristic of a user interface engaged by the user based on the identified demographic group of the user.

In yet another embodiment, the invention can be characterized as capturing voice data from a user; identifying a characteristic feature within the captured voice data; identifying a gender of the user and an age group to which the user belongs based on the characteristic feature identified; selecting a graphical display characteristic of the user interface from a plurality of available graphical display characteristics based upon the gender and age group identified for the user; and presenting the selected graphical display characteristic to the user via the user interface.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 illustrates an exemplary process flow in accordance with many embodiments of the present invention.

FIG. 2 illustrates an exemplary hardware-software system adapted to implement the process flow shown in FIG. 1.

FIG. 3 illustrates an exemplary application of the many embodiments of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

As discussed above, people of different ages and/or different genders respond differently, on average, to people of particular ages and genders in social settings. This fact can be used along with age and/or gender recognition techniques to customize user interfaces experienced by users of particular ages and/or genders.

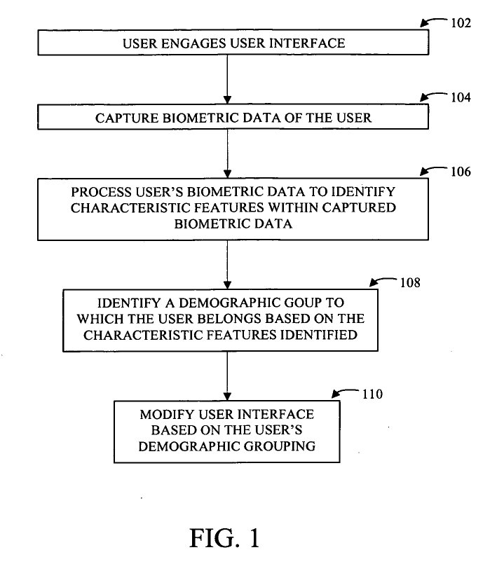

FIG. 1 illustrates an exemplary process flow in accordance with many embodiments of the present invention.

Referring to FIG. 1, a user engages a user interface (step 102), a computer system captures biometric data of the user (step 104), the biometric data is processed to identify characteristic features within the captured biometric data (step 106), a demographic group to which the user belongs is identified based on the identified characteristic features (step 108), and the user interface is modified based upon the user's identified demographic group (step 110).

In one embodiment, the user interface may include a visual- and/or audio-based interface. In one embodiment, the biometric data captured at step 104 may include a user's face and/or a user's voice. Such biometric data can be captured using a suitable camera and/or microphone coupled to a computer system. In one embodiment, the biometric data captured at step 104 can be processed at step 106 by software routines supported by the computer system (e.g., converted into a digital format) and stored in memory local to the computer system. The software routines identify characteristic features of the captured biometric data representing particular age groups (e.g., child, adult, elderly, etc.) and/or gender groups (i.e., male and female). In one embodiment, the software routines identify a particular age grouping and/or gender (collectively referred to as “demographic group”) of the user at step 108 based upon the presence and/or degree to which characteristic feature(s) is (are) identified within the captured biometric data. In one embodiment, the user interface can be modified at step 110 by modifying some presentation characteristic (e.g., the look, sound, informational content, and the like, or combinations thereof) of the user interface based upon the demographic group to which the user belongs. Exemplary characteristics that can be modified based (e.g., in part or in whole) on the demographic group of the user, and the manner in which they can be modified, are discussed in the embodiments that follow.

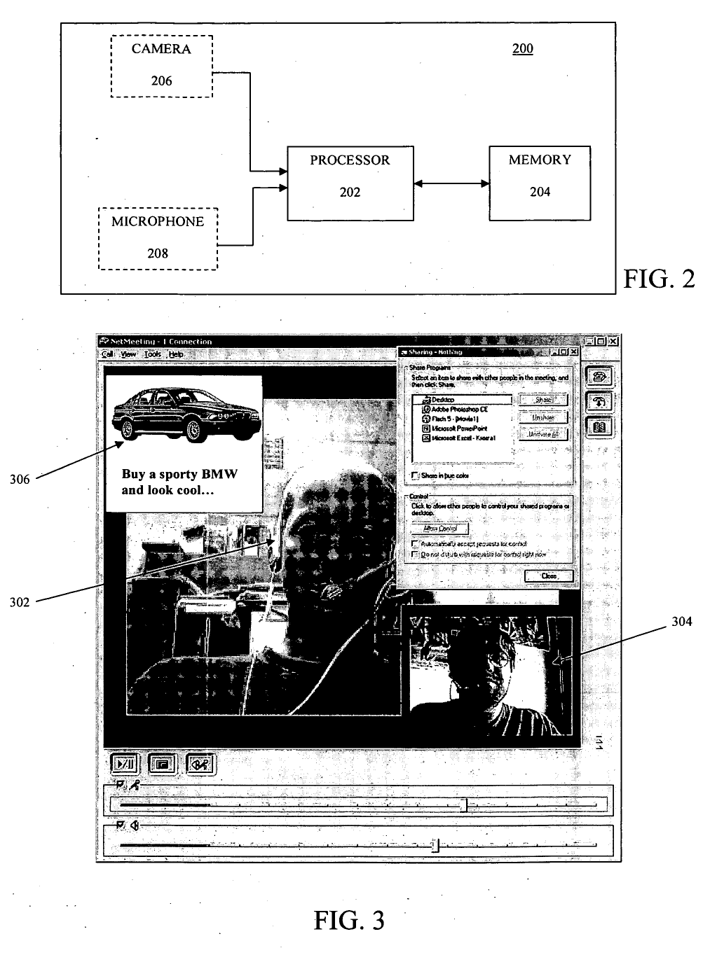

FIG. 2 illustrates an exemplary hardware-software system adapted to implement the process flow shown in FIG. 1.

Referring to FIG. 2, the hardware-software system can be provided as a computer system 200 that includes a processor 202 coupled to memory 204. In embodiments where the biometric data captured includes a an image of a user's face, the computer system 200 further includes a camera 206 coupled to the processor 202 and the processor 202 can be provided with video image processing circuitry adapted to process images captured by the camera 206. In embodiments where the biometric data captured includes a the sound of a user's voice, the computer system 200 further includes a microphone 208 coupled to the processor 202 via an analog-to-digital converter (not shown) and the processor 202 can be provided with voice processing circuitry adapted to process a user's voice captured by the microphone 208. The processor 202 further includes user-interface modification circuitry adapted to modify one or more characteristics of the user interface based on the identified demographic group of the user. As used herein, the term “circuitry” refers to any type of executable instructions that can be implemented as, for example, hardware, firmware, and/or software, which are all within the scope of the various teachings described.

In many embodiments, methods for gender recognition include video image processing of characteristic facial features, audio processing of characteristic vocal signals, and the like, or combinations thereof. Characteristic facial features and characteristic vocal signals can be processed by a computer system to identify males and females with a high degree of accuracy. Using video image processing of facial features and/or audio processing of vocal signals, a computer system equipped with a video camera and/or microphone can automatically identify the gender of a human user who approaches a user interface or interacts verbally with the user interface. Upon identification of the gender of the user, a computer employing the various methods and apparatus disclosed herein can modify one or more characteristics (e.g., the visual, auditory, informational content, and the like, or combinations thereof) of the user interface to be most amenable to the user. In various embodiments, modification of the user interface may be based in whole, or in part, upon the identified gender of the user. Thus, a modified user interface can be referred to as a user interface that has been customized with respect to a particular user.

For example, a user interface may be provided as a monitor incorporated within an ATM machine, wherein the monitor displays a simulated image of a human teller and/or a pre-recorded video image of a human teller. The methods and apparatus disclosed herein can be adapted to identify the gender of the user by processing a video image of the user's face and the look of the teller displayed on the monitor can then be customized according to the identified gender of the user. In this embodiment, a hardware-software system can select and display a specific-looking teller from a pool of teller images according to the identified gender of the user. As a result, male users may be presented with a computer generated image and/or pre-recorded video image of a female teller while female users may be presented with a computer generated image and/or pre-recorded video image of a male teller.

In another example, a user interface may be incorporated within an automated phone service (e.g., an automated customer service processing system), wherein the user interface employs a simulated human operator voice and/or a pre-recorded human operator voice (collectively referred to as “electronic human operator voices”). The methods and apparatus disclosed can be adapted to identify the gender of the user by processing the voice of the user and the sound of the operator can then be customized according to the identified gender of the user. In this embodiment, a hardware-software system can select and display specific-sounding teller from a pool of teller voices according to the identified gender of the user. As a result, male users may be presented with a computer generated voice and/or pre-recorded voice of a female operator and female users with may be presented with a computer generated voice and/or pre-recorded voice of a male operator. In some embodiments of this example, only the sound quality of an operator's voice is varied to represent the different gender of the operator. In other embodiments of this example, specific vocal features (e.g., the speed at which the operator speaks, the sentence structure used by the operator, the vocabulary used by the operator, the formality used by the operator, and/or the type and style of anecdotal references used by the operator, etc.) can be selected from a pool of vocal features to represent the different gender of the operator.

As disclosed herein, age can be used in addition to gender, or instead of gender, to customize characteristics of a user interface. In many embodiments, methods for age recognition include video image processing of characteristic facial features, audio processing of characteristic vocal signals, and the like, or combinations thereof. Characteristic facial features can be processed by a computer system to identify the general age of users sufficiently to identify age groupings of users (e.g., identify whether users are children, young adults, adults, middle aged people, or elderly people). Characteristic vocal signals can be processed by a computer system to sufficiently identify age groupings of users (e.g., identify whether users are children, adults, or elderly people). Using video image processing of facial features and/or audio processing of vocal signals, a computer system equipped with a video camera and/or microphone can automatically identify the general age of a human user who approaches a user interface or interacts verbally with the user interface. Upon identification of the age grouping of the user, a computer employing the various methods and apparatus disclosed herein can customize one or more characteristics (e.g., the visual, auditory, informational content, and the like, or combinations thereof) of the user interface to be most amenable to the user. In various embodiments, customization of the user interface may be based in whole, or in part, upon the identified age grouping of the user.

For example, a user interface may be provided as a monitor incorporated within an ATM machine, wherein the monitor displays a simulated image of a human teller and/or a pre-recorded video image of a human teller. The methods and apparatus disclosed herein can be adapted to identify the age grouping of the user by processing a video image of the user's face and the look of the teller displayed on the monitor can then be customized according to the identified age grouping of the user. In this embodiment, a hardware-software system can select and display a specific-looking teller from a pool of teller images according to the identified age grouping of the user. As a result, children users may be presented with a computer generated image and/or pre-recorded video image of a younger teller while adult users may be presented with a computer generated image and/or pre-recorded video image of an older teller and elderly users may be presented with a computer generated image and/or pre-recorded video image of an even older teller.

In another example, a user interface may be incorporated within an automated phone service (e.g., an automated customer service processing system), wherein the user interface employs a simulated human operator voice and/or a pre-recorded human operator voice. The methods and apparatus disclosed can be adapted to identify the age grouping of the user by processing the voice of the user and the sound of the operator can then be customized based upon the identified age grouping of the user. In this embodiment, a hardware-software system can select and display a specific-sounding teller from a pool of teller voices according to the identified age grouping of the user. As a result, child users may be presented with a computer generated voice and/or pre-recorded voice of a child operator, young adult users may be presented with a computer generated voice and/or pre-recorded voice of a young adult operator, adult users may be presented with a computer generated voice and/or pre-recorded voice of an adult operator, middle aged users may be presented with a computer generated voice and/or pre-recorded voice of a middle aged adult operator, and elderly users may be presented with a computer generated voice and/or pre-recorded voice of an elderly operator. In some embodiments of this example only the sound quality of an operator's voice is varied to represent the different age groupings of the operator. In other embodiments of this example, vocal features (e.g., the speed at which the operator speaks, the sentence structure used by the operator, the vocabulary used by the operator, the formality used by the operator, and/or the type and style of anecdotal references used by the operator, etc.) can be selected from a pool of vocal features to represent the different age groupings of the operator. For example a young adult operator presented to a young adult user via the user interface can be configured to use slang and an informal style while an elderly operator presented to an elderly user via the user interface can be configured not to use slang and to use a more formal style.

In other embodiments, other user interface characteristics can be selected from a pool of user interface characteristics based upon the identified age grouping of the user and be presented to the user via the user interface. For example, simpler user interface menus, questions, and/or choices can be selected from a pool of user interface menus, graphical buttons, questions, choices, etc., and presented (e.g., displayed), via the user interface, to users who are identified as children. Similarly, larger graphical displays of menu choices, graphical buttons, other visually represented interfaces, and data can be selected from a pool of graphical displays of menu choices, graphical buttons, other visually represented interfaces, and data and presented (e.g., displayed) to users who are identified as elderly. As described above, informational content conveyed by the user interface can be selected from a pool of informational content themes based upon the identified age grouping of the user. For example a user identified as a middle aged person or an elderly person can be presented with information content relating to retirement accounts while a user identified as a child or young adult user is not.

In some embodiments wherein user interface characteristics are chosen from a pool of user interface characteristics based upon the identified age grouping and/or gender of the user, the user interface characteristics include the selection of a particular color pallet (i.e., a visual characteristic) from a plurality of color pallets for use in the display of the user interface. For example, a pallet of blues, greens, and/or browns may be selected for male users while a pallet of reds, pinks, and/or yellows may be selected for female users. Similarly, a pallet of bold primary colors may be chosen for child users while a pallet of soft pastels may be chosen for middle-aged users. In some embodiments, the combined age and gender characteristics of the user may be used in the selection of a particular color pallet from a plurality of color pallets for use in the display of the user interface. For example, a color pallet of bright pinks may be chosen for female child user while a color pallet of autumn browns and yellows may be chosen for an elderly man.

The methods disclosed herein can be used with a wide range of devices that any user interacts with. For example the methods disclosed herein can be used with a television set, automatically identifying if one or more users within viewing range of the television are children. If one or more users are children, the available television stations are limited to only those that are appropriate for children. In this case, the informational content of the user interface (i.e., television stations viewable via the television set) is selected from a pool of television stations in accordance with the identified age grouping of one or more users. In some embodiments this is done through the automatic accessing of a V-chip, in other embodiments a V-chip is not needed. As another example, the methods disclosed herein can be used with a television set, automatically identifying if one or more users within viewing range of the television are elderly. If one or more users are identified as elderly, the volume of the audio presented by the television is automatically raised to a higher initial value. In this case, an auditory characteristic of the user interface (i.e., the volume of the audio output by the television set) is selected from a pool of audio volume settings in accordance with the identified age grouping of one or more users.

In some embodiments, the age and/or gender of a user can be identified in whole or in part, based upon previously stored data about the user, wherein the previously stored data is correlated with an identification (ID) associated with the user. For example, a user of an ATM machine has an ID associated with his or her ATM Card, credit card, smart card, radio ID chip, fingerprint, and/or password. Based upon information stored within the card or smart card or radio ID chip, or accessed from local memory or a remote server based upon user identification information received or provided, the computer system can access and/or process information about the age and/or gender of the user. Based upon this information, the look, sound, or other characteristics of the user interface can be updated automatically consistent with the methods disclosed herein.

As discussed above, auditory characteristics (i.e., simulated vocal characteristics) of a user interface can be customized based upon the automatically identified age and/or gender of a user. In another embodiment, other auditory characteristics of a user interface (e.g., background music) can be customized to be most amenable to the user. In various embodiments, selection of a type of background music (i.e., a background music item) played by a user interface may be based in whole, or in part, upon the identified age grouping and/or gender of the user.

For example, when a user approaches a computer system that provides background music as part of the user interface, the methods and apparatus disclosed herein can identify the general age-group of the user by processing a video image of the user's face and then can customize the background music played to the user based upon the identified age-group of the user. As a result, child users may be presented with child-appropriate music (e.g., children's songs), adult users may be presented with popular adult music (e.g., soft-rock, jazz, etc.), and elderly users may be presented with music typically enjoyed by their age group (e.g., classical music, big band music, etc.).

In another example, when a user calls an automated phone service (e.g., an automated customer service processing system) that provides background music during a conversation or during times when the user is on hold (i.e. music-on-hold), the methods and apparatus disclosed can identify the general age group that the user falls into by processing the voice of the user and then can customize the music played to the user. As a result, child users may be presented with child-appropriate music (e.g., children's songs), young adult users may be presented with music most popular among young adults (e.g., rap, pop music, etc.), middle-aged users may be presented with music more generally liked by people of their age group (e.g., classic rock, soft-rock, jazz, etc.), and elderly users may be presented with music more generally enjoyed by their age group (e.g., classical music, big band music, etc).

In some embodiments, a hardware-software system can select and play music to users, wherein the music can be selected from a pool of available songs, based in whole or in part upon the automatically identified age grouping of a user. In addition to, or instead of using the automatically identified age grouping of a user to select and play music to a user, the automatically identified gender of a user can be used by the hardware-software system to select and play music to a user based upon the methods disclosed herein. For example, when a user approaches a computer system that provides background music as part of the user interface, the methods and apparatus disclosed herein can identify the gender of the user by processing a video image of the user's face and then can customize the background music played to the user based upon the identified gender of the user. As a result, male users may be presented with songs that appeal more to males (e.g., rock-anthems, etc) and females may be presented with songs that appeal more to females (e.g., love-longs and ballads).

In another example, when a user calls an automated phone service (e.g., an automated customer service processing system) that provides background music during a conversation or during times when the user is on hold (i.e. music-on-hold), the methods and apparatus disclosed can identify the gender of that user by processing the voice of the user and then can customize the music played to the user. As a result, male users may be presented with songs that appeal more to males (e.g., rock-anthems, etc) and females may be presented with songs that appeal more to females (e.g., love-longs and ballads). As discussed above, the automatically identified gender can be used in conjunction with other factors used by the software to select a type of music to play to a user from a pool of available music. For example, gender can be used in conjunction with an automatically identified age-grouping of a user to select music from a pool of available music, wherein the music customized to be most appealing to the identified age group and gender of the particular user.

As described above, informational content conveyed by a user interface can be customized based upon the automatically identified age and/or gender of the user. In some embodiments, informational content can include advertisements that are displayed to a user, wherein the displayed advertisements can be chosen from a pool of available advertisements based upon the automatically identified age and/or gender of the user. Hardware and software systems disclosed herein can select and play customized advertisements in public places wherein people enter and exit the vicinity of computer displays. Using the systems and methods disclosed herein, a computer can automatically identify the age grouping and/or gender of a user entering within the vicinity thereof (e.g., by processing an image of the user's face and/or processing an audio signal of the user's voice). The computer can then access a particular computer file containing an advertisement from a pool of available advertisements based upon the identified age and/or gender of the user and play the accessed advertisement for that user. In one embodiment, the pool of available advertisements includes a plurality of similar advertisements (e.g., advertisements of the same product), wherein each advertisement is customized to target different age and/or gender groups. In another embodiment, the pool of available advertisements includes a plurality of dissimilar advertisements (e.g., advertisements for different products), wherein different advertisements advertise products targeted to different age and/or gender groups. In this way, advertisements can be targeted to users of appropriate age and/or gender using an automated age and/or gender recognition system that requires no explicit data input from the user and/or data exchange with the user and/or prior information about the user. Such a system may be ideal for public places wherein unknown users enter and exit a space at will.

For example, when a user approaches the computer system, the methods and apparatus disclosed herein can automatically identify the general age-group of the user by processing a video image of the user's face and then select and display an advertisement from a pool of available advertisements based upon the identified age-group of the user. As a result, child users may be presented with child-appropriate advertisements (e.g., advertisements for children's toys, children's cereal, etc.), adult users may be provided with adult appropriate advertisements (e.g., advertisements for coffee, car insurance, etc.), and elderly users may be presented with elderly appropriate advertisements (e.g., advertisements for arthritis medication, etc.).

In another example, when a user calls an automated phone service (e.g., an automated customer service system) that provides audio advertisements during times when the user is on hold (i.e. advertisement-on-hold), the methods and apparatus disclosed herein can identify the likely age group that the user falls into by processing the voice of the user as it is captured by a microphone (e.g., the microphone on the user's phone). In one embodiment, the user's voice captured by the microphone can be processed through known digital signal processing techniques and identify key vocal characteristics representative of certain age groups. Based in whole or in part upon the identified vocal characteristics of the user's voice, the age grouping of the user is identified by software routines. Based in whole or in part upon the identified age grouping, software associated with the automated customer service system then selects an advertisement from an available pool of stored advertisements that is most likely appropriate for and/or targets the age grouping identified for the particular user. The selected advertisement is then played to the user. As a result, child users may be presented with child-appropriate advertisements (e.g., advertisements for children's toys, children's cereal, etc.), young adult users may be presented with advertisements appropriate for young adults (e.g., advertisements for pop music, action movies, etc.), middle-aged users may be presented with advertisements appropriate for middle-aged people (e.g., advertisements for drugs such as Viagra and Rogaine, advertisements for luxury automobiles, etc.) and elderly users may be presented with advertisements appropriate for elderly people (e.g., advertisements for arthritis medication, etc.).

As disclosed in the paragraph above, a hardware-software system can be adapted to select and present (e.g., play or display) advertisements to users, wherein the advertisements are selected from a pool of available advertisements based in whole or in part upon the automatically detected age grouping of a user. In addition to, or instead of using the automatically identified age grouping of a user to select and present advertisements to a user, the automatically identified gender of a user may be used by a hardware-software system to select and present advertisements to a user based upon the methods disclosed herein. For example, when a user approaches a computer system that provides advertisements, the methods and apparatus disclosed herein can identify the gender of the user by processing a video image of the user's face and then can select an advertisement from a pool of available advertisements based in whole or in part upon the identified gender of the user. As a result, male users may be presented with advertisements that target male consumers (e.g., advertisements for products such as shaving cream, electric razors, etc.) and female users may be presented with advertisements that target female consumers (e.g., advertisements for products such as facial makeup, calcium supplements, etc.).

In another example, when a user calls an automated phone service (e.g., an automated customer service system) that provides audio advertisements during times when the user is on hold (i.e. advertisement-on-hold), the methods and apparatus disclosed herein can identify the gender of the user by processing the voice of the user as captured by a microphone (e.g., the microphone on the user's phone). In one embodiment, the user's voice captured by the microphone can be processed through known digital signal processing techniques and identify key vocal characteristics representative of each gender. Based in whole or in part upon identified vocal characteristics of the user's voice, the gender of the user can be identified by software routines. Based in whole or in part upon the identified gender, software associated with the automated customer service system then selects an advertisement from a pool of stored advertisements that is most likely appropriate for and/or targets the gender identified for the particular user. The selected advertisement is then played to the user. As a result, male users may be presented with advertisements that target male consumers (e.g., advertisements for products such as shaving cream, electric razors, etc.) and female users may be presented with advertisements that target female consumers (e.g., advertisements for products such as nylons, sports-bras, etc.). As discussed above, the automatically identified gender can be used in conjunction with other factors used by the software to select advertisements to present to a user from the pool of available advertisements. For example, gender can be used in conjunction with automatically identified age-grouping of a user to select advertisements from a pool of available advertisements wherein the advertisement is appropriate and/or targeted to the identified age group and gender of the particular user.

In some embodiments, a user's age and/or gender can be used to refine the serving of relevant advertisements as dictated by internet-based methods. For example, an advertising topic or advertising topics can be determined based upon a content analysis of one or more documents retrieved by a user over the internet. Once one or more advertising topics have been determined, a pool of advertisements (i.e., topic-related advertisements) are identified as being relevant to the one or more advertising topics. Finally a specific advertisement is selected from the pool of topic-relevant advertisements based in whole or in part upon the automatically identified age group and/or gender of the user. As described in previous examples, the age group and/or gender of the user can be automatically identified based in whole or in part upon a captured image of the user and/or upon a recorded audio sample of the user's voice.

As an example of the internet-based method described above, an embodiment of the present invention provides a computer interface located in a public place. The computer interface can be approached by a user allow a user to access a document (e.g., including textual references to luxury cars) over the internet. Content analysis circuitry within the computer interface (e.g., within the aforementioned processor 202) then performs a content analysis upon the document accessed by the user. Based on the content analysis, the computer interface determines “luxury cars” as a relevant advertising topic. A pool of, for example, twenty possible topic-related advertisements are then identified as being relevant to the “luxury car” advertising topic. The user's age grouping and/or gender is then identified (or has already been identified at some previous time since the user approached the computer interface) based upon an image of the user's face (e.g., as captured and recorded as digital image data by a digital camera) and/or a sample of the user's voice (e.g., as captured and by a microphone and converted into digital voice data by an analog-to-digital converter), wherein the age grouping and/or gender is identified by local software routines that identify age-related characteristics and/or gender-related characteristics from the image data and/or voice data. Based in whole or in part upon the identified age group and/or gender of the user, a specific topic-related advertisement is selected from the pool of advertisements which are relevant to the advertising topic of luxury cars and the selected topic-related advertisement is presented to the user. For example, if the user is identified as a male in his late-twenties, the topic-related advertisement selected from the pool of advertisements which are relevant to the advertising topic of luxury cars would be particularly relevant to male's in their late-twenties. In this case, the topic-related advertisement selected can be an advertisement for a sporty convertible BMW. If, on the other hand, the user is identified as a female in her late-sixties, a different topic-related advertisement (i.e., a topic-related advertisement particularly relevant to females in their late-sixties) is selected from the pool of advertisements which are relevant to the advertising topic of luxury cars. In this case, the topic-related advertisement selected can be an advertisement for a large and stately Lexus sedan.

To support the advertising-related methods disclosed herein, some embodiments include data associated with each of the available advertisements that indicate the target audience for the advertisements based upon gender and/or age. The data can be stored locally or accessed from a remote server.

In some embodiments, a conversation stream is used in addition to, or instead of a document retrieved over the internet for content analysis. For example, when two or more users communicate with each other over the internet, the content of their conversation may be processed in much the same way that documents are processed for their content. Accordingly, a conversation between two or more users can be represented as voice data, text data, and/or video data. Moreover, content analysis can be performed as in real time as conversations are being communicated (e.g., as a live and interactive dialog) or as communications are stored and transmitted. For example, and with reference to FIG. 3, a computer system equipped with internet communication software such as Netmeeting from Microsoft, Webex from Webex, or Yahoo Messenger from Yahoo can be used to allow two users 302 and 304 to engage each other in a conversation over the internet using web-cams and microphones that communicate voice and images in real time. A content analysis is performed upon this conversation stream using voice recognition technology and content analysis routines. The voice stream of the conversation may, for example, include verbal references by one or both parties to “luxury cars.” When the content analysis is performed upon this conversation stream using voice recognition technology and content analysis routines, the content analysis identifies luxury cars as a relevant advertising topic for the users engaged in the conversation. A pool of twenty possible topic-related advertisements is then identified for these users, the topic-related advertisements being relevant to the advertising topic of luxury cars. The age grouping and/or gender of one, or both, of the users engaged in the conversation is then determined (or has already been identified at some previous time since the users engaged in conversation) based upon an image of the user's face (e.g., as captured and recorded as digital image data by a digital camera) and/or a sample of the user's voice (e.g., as captured and by a microphone and converted into digital voice data by an analog-to-digital converter), wherein the age grouping and/or gender is identified by processing hardware and software routines local to the particular user that identify age-related characteristics and/or gender-related characteristics from the image data and/or voice data. Based in whole or in part upon the age and/or gender identified of either of the users, a specific topic-related advertisement is selected from the pool of advertisements which are relevant to the advertising topic of luxury cars and the selected topic-related advertisement is presented to each of the users. For example, if one of the users in the conversation is identified as a male in his late-twenties, the topic-related advertisement selected from the pool of advertisements which are relevant to the advertising topic of luxury cars would be particularly relevant to male's in their late-twenties. In this case (and as shown at 306), the topic-related advertisement selected can be an advertisement for a sporty convertible BMW. If, the other hand, one of the users in the conversation is identified as a female in her late-sixties, a different topic-related advertisement (i.e., a topic-related advertisement particularly relevant to females in their late-sixties) is selected from the pool of advertisements which are relevant to the advertising topic of luxury cars. In this case, the topic-related advertisement selected can be an advertisement for a large and stately Lexus sedan. In this way, a plurality of users engaged in an internet-based conversation about the same topic from remote locations using separate computer interfaces can each be presented with different topic-related advertisements, all relevant to the same advertising topic that is relevant to the group conversation but specifically selected based upon the identified age-group and/or gender of each individual user.

In some embodiments, the methods and apparatus for performing a content analysis upon an internet-based conversation stream as described above can also be applied to systems that do not employ the internet as the communication medium. For example, the methods and apparatus described above may be adapted to perform a content analysis of conversation streams communicated over a cell phone network. For example, when two users engage in a conversation over a cell phone network using voice and video images, a content analysis can be performed upon the conversation stream using voice recognition technology and content analysis routines. The content analysis identifies one or more relevant advertising topics for the two users who are currently engaged in conversation. A pool of possible topic-related advertisements, relevant to the identified advertising topic(s), is then identified for these users. The age grouping and/or gender of one or both of the users engaged in the conversation is then identified (or has already been identified at some previous time since the users engaged in conversation) based upon based upon an image of the user's face (e.g., as captured and recorded as digital image data by a digital camera) and/or a sample of the user's voice (e.g., as captured and by a microphone and converted into digital voice data by an analog-to-digital converter), wherein the age grouping and/or gender is identified by local processing hardware and software routines in their cell-phones that identify age-related characteristics and/or gender-related characteristics from the image data and/or voice data. Based in whole or in part upon the age and/or gender identified of either of the users, a specific topic-related advertisement is selected from the pool of advertisements which are relevant to the determined advertising topic(s). In this way, a plurality of users engaged in a cell-phone based conversation about the same topic from remote locations using separate local processing hardware and software routines in their cell phones can each be presented with different topic-related advertisements via their cell phones, all relevant to the group conversation but specifically selected based upon the identified age-group and/or gender of each individual user.

In some embodiments, hardware-software systems can be implemented with human operators instead of, or in addition to automated and/or pre-recorded operators. For example, the methods and apparatus described above can be applied to customer service systems that function by telephone and employ a pool of human operators to take phone calls from customers. Similarly, the methods and apparatus described above can be applied to customer service systems that function by internet connection using voice and/or web-cams to connect users with one or more representatives from a pool of human operators. Accordingly, the methods and apparatus described above can facilitate gender-selective routing and/or age-selective routing wherein the age group and/or gender of a user is identified and, based on the identified age group and/or gender, the user is automatically routed by software to one human operator out of a pool of available human operators. As a result, a male user can be automatically connected to a female human operator and a female user can be automatically connected to a male human operator. Similarly, a child user can be automatically routed to a child-friendly human operator while an elderly user can be automatically routed to a human operator who is trained on, knowledgeable about, or otherwise sensitive to the unique needs to elderly callers. In this way, users can be automatically connected to a human operator that is selected from a pool of available operators who is likely to be appropriate for the user's needs (either because the age group and/or gender of the operator will likely be comfortable for that user, or because the training, background, knowledge, or expertise of that operator is appropriate for a user of that age and/or gender).

In one example, a user calls an automated phone system such as a customer service line. An automated prompt then asks that user to answer a question, such as “What is your name?” Alternatively, the user voluntarily engages the system by speaking to it, for example making a request for customer service or some other service. The user's voice is then recorded as voice data and processed using the methods and apparatus disclosed herein above. The age grouping and/or gender of the user is then identified based upon characteristic features present in the voice data. That user is then connected to a human operator, selected from a pool of available human operators, based in whole or in part upon the automatically identified age grouping and/or gender made based upon the user's voice.

In another example, a user connects to an automated internet-based system such as a customer service system that functions through an internet web page. An automated prompt and/or user interface display then asks that user to answer a question, such as “What is your name?” Alternatively, the user voluntarily engages the system by speaking to it, for example making a request for customer service or some other service. The user's voice is then recorded as voice data and processed using the methods and apparatus disclosed herein above. The age grouping and/or gender of the user is then identified based upon characteristic profiles present in the voice data. That user is then connected to a human operator, selected from a pool of available human operators, based in whole or in part upon the automatically identified age grouping and/or gender made based upon the user's voice. Additionally or alternatively, the user's face can be captured as an image by a camera located local to the user and connected to the computer system either directly or through a client-server system, either through a wired or wireless connection. The user's face image data is then processed using the methods and apparatus disclosed herein above. The age grouping and/or gender of the user is then identified based upon characteristics present in the image data. That user is then connected to a human operator, selected from a pool of available human operators, based in whole or in part upon the automatically identified age grouping and/or gender made based upon the user's face.

In some embodiments of the present invention, use of the automatically identified age and/or gender may be used to modify both an automated operator and select a human operator from a pool of available operators. For example, some customer service systems provide an automated operator for general functions but route users to a human operator for select functions, such as to address topics that are beyond the scope of the automated response system. In such a system, the methods and apparatus disclosed herein support both the automated portion of the system by selecting, updating, and/or modifying the automated user interface based upon the automatically identified age and/or gender of the user and the human operator portion of the system by routing users to human operators that are selected based in whole or in part upon the automatically identified age and/or gender of the user.

In some embodiments, the methods and apparatus disclosed herein can be implemented in conjunction with computerized gaming systems and/or computerized entertainment systems wherein, for example, a simulated character is portrayed graphically to represent the user within the game scenario. In most cases, male users prefer a male portrayal within the gaming system and female users prefer female portrayal within the gaming system. Using the methods and apparatus disclosed herein, a gaming system and/or entertainment system can be configured to automatically select and portray a character to match the gender of a user based in whole or in part upon the automatically identified gender of the user. In some embodiments, the gender of the user can be automatically identified based upon the user's voice. In other embodiments the gender of the user can be automatically identified based upon the user's facial features. In other embodiments, both the voice and facial features of the user can be used. In addition to, or instead of being used to automatically select the gender of a character used to portray the user within a gaming and/or entertainment software system, the gender of supporting characters (e.g., simulated friends and/or teammates) may also be automatically selected and/or influenced based in whole or in part upon the automatically identified gender of the user.

In addition to, or instead of selecting and/or influencing the gender of characters within a gaming and/or entertainment software system, the methods and apparatus disclosed herein can be used to configure a gaming system and/or entertainment system to automatically select and portray a user-controlled character to match the age of that user based in whole or in part upon the automatically identified age group of the user. In some embodiments, the age of the user can be automatically identified based upon the user's voice. In other embodiments, the age of the user can be automatically identified based upon the user's facial features. In other embodiments, both voice and facial features of the user can be used. In addition to, or instead of being used in selecting and/or influencing the age of a character used to portray the user within a gaming and/or entertainment software system, the age of supporting characters (e.g., simulated friends and/or teammates) may also be automatically selected and/or influenced based in whole or in part upon the automatically identified age of the user.

In some embodiments, the methods and apparatus disclosed herein may be used to gather data about users and correlate the gathered data with the automatically identified age group and/or gender of the users. For example, a public computer system in a supermarket could be configured, using the methods and apparatus disclosed herein, to answer questions for users about products, produce, and/or other merchandise available in the supermarket. As described previously, the system can be configured to automatically update the user interface based upon the automatically identified age group and/or gender of the user who is engaging the public computer system in the supermarket. In one embodiment, the public computer system can also include activity recordation circuitry (e.g., within the aforementioned processor 202) configured to record data about a user's behavior and correlate the recorded data with the automatically identified age group and/or gender of the user. For example, data identifying which product or products a given user inquires about can be recorded and the recorded data can be correlated with the automatically identified age group and/or gender of the user. By storing such data for a plurality of users (e.g., a large number of users), software within the public computer system can generate and maintain a demographic database that correlates user behavior with user age group and/or gender. This correlated data can then be used to better tailor the user interface for future users based upon the then identified age group and/or gender of the future users. For example, the demographic data collected using the methods disclosed herein may indicate that a significant percentage of male users who are middle-aged inquire about a certain feature of a certain product. Based upon this demographic data, the user interface can be automatically tailored for future users who approach and/or engage the system. For example, when a future user approaches the system and is identified automatically by the system as being male and middle-aged, information about that certain feature of that certain product is automatically conveyed. Conversely, when a future user approaches and/or engages the system who is not male and/or not middle-aged, information about that certain feature of that certain product is not automatically conveyed. In this way, the system tailors the information content that is provided to individual users, and/or modifies the manner in which information is provided to individual users, based both upon the automatically identified age group and/or gender of that individual user and a stored demographic database that correlates the behaviors and/or preferences of past users with the automatically identified age and/or gender of the past users.

While the invention herein disclosed has been described by means of specific embodiments, examples and applications thereof, numerous modifications and variations could be made thereto by those skilled in the art without departing from the scope of the invention set forth in the claims.

What is claimed is:

1. A method of customizing a user interface with respect to a user, comprising:
capturing biometric data of a user engaging a user interface;
identifying at least one characteristic feature within the captured biometric data;
identifying a demographic group to which the user belongs based on the at least one characteristic feature identified; and
modifying a presentation characteristic of the user interface based on the identified demographic group of the user.

2. The method of claim 1, wherein the step of capturing biometric data includes capturing a user's voice via a microphone.

3. The method of claim 1, wherein the step of capturing biometric data includes capturing an image of a user's face via a camera.

4. The method of claim 1, wherein the step of capturing biometric data includes:
obtaining previously stored biometric data of the user;
obtaining an identification associated with the user; and
correlating the previously stored biometric data with the identification.

5. The method of claim 1, wherein the step of identifying a demographic group includes identifying the gender of the user.

6. The method of claim 1, wherein the step of identifying a demographic

7. The method of claim 1, wherein the step of modifying a presentation characteristic of the user interface includes modifying a visual characteristic of the user interface.

8. The method of claim 7, wherein the step of modifying a visual characteristic of the user interface includes:
selecting a color pallet from a plurality of available color pallets; and
presenting the selected color pallet to the user via the user interface.

9. The method of claim 1, wherein the step of modifying a presentation characteristic of the user interface includes modifying an auditory characteristic of the user interface.

10. The method of claim 9, wherein the step of modifying an auditory characteristic of the user interface includes:
selecting a background music item from a plurality of available background music items; and
playing the selected background music item to the user via the user interface.

11. The method of claim 9, wherein the step of modifying an auditory characteristic of the user interface includes:
selecting an electronic human operator voice from a plurality of available electronic human operator voices; and
playing the selected electronic human operator voice to the user via the user interface.

12. The method of claim 1, wherein the step of modifying a presentation characteristic of the user interface includes modifying informational content presented by the user interface.

13. The method of claim 1, further comprising presenting an advertisement to the user based on the identified demographic group of the user.

14. The method of claim 13, further comprising:
analyzing an activity of the user engaging the user interface;
determining an advertising topic based upon the analyzed activity; and
selecting an advertisement related to the determined advertising topic to be presented to the user.

15. The method of claim 14, further comprising:
identifying a plurality of advertisements related to the determined advertising topic, wherein
the step of selecting an advertisement includes selecting an advertisement from the plurality of advertisements related to the determined advertising topic.

16. The method of claim 15, wherein the step of analyzing the activity of the user includes analyzing the content of documents accessed by the user.

17. The method of claim 15, wherein the step of analyzing the activity of the user includes analyzing the content of a conversation to which the user is a part.

18. The method of claim 1, further comprising:
recording an activity of the user engaging the user interface;
correlating the recorded activity with the identified demographic group of the user; and
storing data representing the user's recorded activity correlated with the identified demographic group of the user, wherein
the step of modifying a presentation characteristic of the user interface includes modifying a presentation characteristic of the user interface based on the identified demographic group of the user engaging the user interface and the stored data.

19. An apparatus for customizing a user interface with respect to a user, comprising:
biometric recognition circuitry adapted to:
identify a characteristic feature within captured biometric data of a user engaging a user interface; and
identify a demographic group to which the user belongs based on the characteristic feature identified; and
user interface modification circuitry adapted to modify a presentation characteristic of a user interface engaged by the user based on the identified demographic group of the user.

20. The apparatus of claim 19, further comprising a microphone adapted to capture the user's voice, wherein the biometric recognition circuitry is adapted to identify a characteristic feature within the user's voice.

21. The apparatus of claim 19, further comprising a camera adapted to capture an image of the user's face, wherein the biometric recognition circuitry is adapted to identify a characteristic feature within the image of the user's face.

22. The apparatus of claim 19, wherein the biometric recognition circuitry is further adapted to identify the gender of the user.

23. The apparatus of claim 19, the biometric recognition circuitry is further adapted to identify an age group to which the user belongs.

24. The apparatus of claim 19, wherein the user interface modification circuitry is adapted to modify a visual characteristic of a user interface engaged by the user.

25. The apparatus of claim 24, wherein the user interface modification circuitry is adapted to:
select a color pallet from a plurality of available color pallets; and
present the selected color pallet to the user via the user interface.

26. The apparatus of claim 19, wherein the user interface modification circuitry is adapted to modify an auditory characteristic of a user interface engaged by the user.

27. The apparatus of claim 26, wherein the user interface modification circuitry is adapted to:
select a background music item from a plurality of available background music items; and
play the selected background music item to the user via the user interface.

28. The apparatus of claim 26, wherein the user interface modification circuitry is adapted to:
select an electronic human operator voice from a plurality of available electronic human operator voices; and
play the selected electronic human operator voice to the user via the user interface.

29. The apparatus of claim 19, wherein the user interface modification circuitry is adapted to modify informational content presented to the user by the user interface.

30. The apparatus of claim 19, wherein the user interface modification circuitry is adapted to select an advertisement to be presented to the user by the user interface.

31. The apparatus of claim 30, further comprising content analysis circuitry adapted to:
analyze an activity of the user engaging the user interface; and
determine an advertising topic based upon the analyzed activity, wherein
the user interface modification circuitry is further adapted to select an advertisement related to the determined advertising topic to be presented to the user.

32. The apparatus of claim 31, wherein the user interface modification circuitry is adapted to:
identify a plurality of advertisements related to the determined advertising topic; and
select an advertisement from the plurality of advertisements related to the determined advertising topic.

33. The apparatus of claim 32, wherein content analysis circuitry is adapted to analyze the content of documents accessed by the user.

34. The apparatus of claim 32, wherein content analysis circuitry is adapted to analyze the content of a conversation to which the user is a part.

35. The apparatus of claim 19, further comprising activity recordation circuitry adapted to:
record an activity of the user engaging the user interface;
correlate the recorded activity with the identified demographic group of the user; and
store data representing the user's recorded activity correlated with the identified demographic group of the user, wherein
the user interface modification circuitry is adapted to modify a presentation characteristic of a user interface engaged by the user based on the identified demographic group of the user and the stored data.

36. A method of customizing a user interface with respect to a user, comprising:
capturing voice data from a user;
identifying at least one characteristic feature within the captured voice data;
identifying a gender of the user and an age group to which the user belongs based on the at least one characteristic feature identified;
selecting a graphical display characteristic of the user interface from a plurality of available graphical display characteristics based upon the gender and age group identified for the user; and
presenting the selected graphical display characteristic to the user via the user interface.
